(19) United States
(12) Patent Application Publication
(10) Pub. No.: US 2014/0257829 A1
(43) Pub. Date: Sep. 11, 2014

(54) INTERACTIVE HEALTHCARE MODELING

(71) Applicant: Archimedes, Inc., (US)

(72) Inventors: Charles Andrew Schuetz, Piedmont, CA (US); Marc-david Cohen, San Anselmo, CA (US)

(73) Assignee: Archimedes, Inc., San Francisco, CA (US)

(21) Appl. No.: 13/791,810

(22) Filed: Mar. 8, 2013

(51) Int. Cl. G06F 19/00

(52) U.S. Cl. CPC G06F 19/3437
USPC 705/2

(57) ABSTRACT

A method comprises receiving a prediction request that comprises a population definition and one or more healthcare treatment criteria specifying a treatment scenario; in response to receiving the prediction request, performing in a real-time: parsing the prediction request to identify the population definition and the one or more healthcare treatment criteria; mapping the one or more healthcare treatment criteria to a function of one or more input variables to determine a particular dataset, from a plurality of datasets; based, at least in part, on the population definition and the particular dataset, determining a response surface; determining prediction data by estimating, using the response surface which approximates the healthcare simulation model, simulation results that using the healthcare simulation model would yield; returning the prediction data.

### TECHNICAL FIELD

The present disclosure generally relates to using computers for interactive healthcare modeling and for predicting health and economic effects of healthcare interventions.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Computer program applications have been developed to provide predictions of health effects of various medical treatments on patients. However, generating the predictions is often resource-demanding because it usually requires running computationally expensive simulations, accessing large amounts of data and performing complex data analyses, all of which require significant data processing and storing power.

Further, due to its complexity, generating predictions may take a great deal of time, causing a significant delay in providing the prediction results to a user. However, the delay is highly undesirable because the user would expect the system to be interactive to a large degree, and would prefer to receive the predictions rapidly.

Interactivity of a prediction system is also important to a user in terms of the ability to repeatedly request modifications and receive results to each of the modified requests successively in an interactive fashion. A convenient and user-friendly manner in which the user may interact with the prediction system makes it easier for the user to determine how even the smallest changes in a healthcare treatment may potentially impact a patient's health.

### BRIEF DESCRIPTION OF THE DRAWINGS

In the drawings:

FIG. 1 illustrates a system on which an embodiment may be implemented;

FIG. 2 illustrates an example method for generating prediction response data;

FIG. 3 illustrates an example method for generating a response dataset;

FIG. 4a illustrates an example of a matrix generated using an experimental design approach;

FIG. 4b illustrates an example of a database table generated using an experimental design approach;

FIG. 4c illustrates an example of computer experiments and observed responses associated with the 2² central composite factorial design for a particular subpopulation;

FIG. 5 illustrates an example computer system upon which an embodiment of the approach may be implemented.

### DESCRIPTION OF EXAMPLE EMBODIMENTS

Approaches for estimating healthcare costs and benefits for individuals are described. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention. Embodiments are described herein according to the following outline:
1.0 General Overview
2.0 Structural and Functional Overview
3.0 Generating Response Dataset
4.0 Generating Prediction Response Data
5.0 Example of Generating Response Dataset
6.0 Example of Generating Prediction Response Data
7.0 Implementation Mechanisms—Hardware Overview

1.0 General Overview

In an embodiment, a computer-implemented method comprises receiving a prediction request that comprises a population definition and one or more healthcare treatment criteria specifying a treatment scenario. A prediction request may comprise a variety of requests and criteria further specifying the request. For example, the prediction request may comprise a request to predict effects of a treatment scenario on individuals of a certain population.

In an embodiment, in response to receiving the prediction request, the following is performed in real-time: the prediction request is parsed to identify the population definition and the one or more healthcare treatment criteria; the one or more healthcare treatment criteria are mapped to a function of one or more input variables to determine a particular dataset, from a plurality of datasets; based, at least in part, on the population definition and the particular dataset, a response surface is determined; prediction data is determined by estimating, using the response surface which approximates the healthcare simulation model, simulation results that using the healthcare simulation model would yield; and the prediction data is returned.

In an embodiment, the prediction request comprises a request to predict effects of the treatment scenario on individuals specified by the population definition.

In an embodiment, the response surface is generated according to an experimental design. The experimental design may be a matrix describing a set of experiments and simulations performed using any one of a plurality of healthcare models.

In an embodiment, the response surface allows comparing effects of the treatment scenario, specified by the one or more healthcare treatment criteria, on individuals specified by the population definition; determining one or more optimum patient populations for the treatment scenario; and determining one or more optimum treatment scenarios for the individuals specified by the population definition.

In an embodiment, a computer-implemented method comprises receiving a plurality of combinations of input variables, each of the plurality of combinations of input variables comprising health data. The method also comprises retrieving, from a plurality of healthcare models, a particular healthcare model that accepts the plurality of combinations of input variables.

In an embodiment, for each of the plurality of combination of input variables: a response dataset is generated. Generating of the response dataset may be achieved by performing one or more healthcare model simulations using the particular healthcare model and the input variables by varying values of the input variables using an experimental design, and determining values of response variables.

In an embodiment, the method further comprises storing the response dataset in a database.

In an embodiment, the one or more healthcare model simulations comprise performing a statistical analysis.

In an embodiment, the plurality of combinations of input variables comprises any one of: population-related data and treatment-scenario data.

In an embodiment, the plurality of combinations of input variables comprises any one data of: treatment data, biomarkers data, disease risk data and population data; wherein the response variables comprise any one data of: disease event rates and other statistical information.

In an embodiment, a method is performed by one or more computing devices.

The foregoing and other features and aspects of the disclosure will become more readily apparent from the following detailed description of various embodiments.

2.0 Structural and Functional Overview

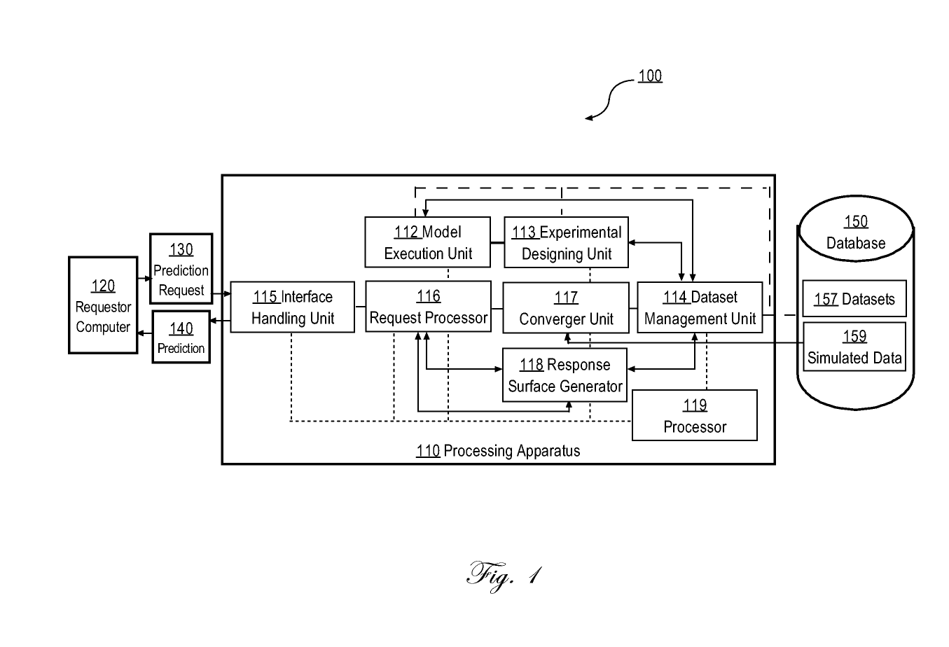

FIG. 1 illustrates a computer system 100 on which an embodiment may be implemented. The system 100 comprises a data processing apparatus 110, and a database 150. The processing apparatus 110 is communicatively coupled with a requestor computer 120, from which the processing apparatus receives one or more prediction requests 130, and to which the processing apparatus transmits one or more predictions 140.

In an embodiment, a requestor computer 120 is configured to receive from a user a prediction request 130, and transmit the prediction request to processing apparatus 110. A user may be a patient who uses the system 100, a healthcare professional, a healthcare provider manager and other entity that may use the system. A prediction request 130 may be provided via a web browser launched on requestor computer 120, via a command line entered on the requestor computer, or provided in any other form in which the requestor computer may accept data input.

Requestor computer 120 may also be configured to receive a prediction 140 from processing apparatus 110, and communicate the received prediction to the sender of the prediction request 130. The prediction 140 may be received in a form of a webpage that can be displayed in a web browser launched on requestor computer 120, or displayed in any other form in which the requestor computer may accept data input.

Requestor computer 120 may be part of a processing apparatus 110. Alternatively, a requestor computer 120 may be a user workstation executing a third-party software application configured to generate an application programming interface (API), from which a user may issue a prediction request.

Requestor computer 120 may be a workstation, a personal computer or a portable computing device. In an embodiment, the requestor computer 120 is configured to execute a web browser application for sending prediction requests to the processing apparatus 110, and receiving predictions from the processing apparatus 110.

In an embodiment, processing apparatus 110 comprises a processor 119, a model execution unit 112, an experimental designing unit 113, a dataset management unit 114, an interface handling unit 115, a request processor 116, a converger unit 117, and a response surface generator 118. Processor 119 may comprise a general-purpose central processing unit (CPU).

Database 150 is coupled and accessible to at least the model execution unit 112, the experimental designing unit 113 and the dataset management unit 114. The database 150 comprises one or more datasets 157 and one or more sets of simulated data 159.

Dataset 157 may correspond to a response dataset that maps a plurality of combinations of input variables to values of response variables according to a healthcare model. A healthcare model may be a software application configured to accept various combinations of input variables and to perform an experimental design simulation to derive values of response variables.

One or more simulated data 159 may include data for simulated patients for which one or more datasets 157 have been generated using any one of the healthcare models.

Processing apparatus 110 may be configured to receive a prediction request 130, generate an answer to the prediction request 130, and provide prediction 140. A prediction request 130 may comprise a population definition and one or more healthcare treatment criteria specifying a treatment scenario. The treatment scenario may be defined by the one or more healthcare treatment criteria. In an embodiment, a prediction request 130 is a request to predict effects of the treatment scenario on individuals who are specified in the population definition.

Functionalities of processing apparatus 110 may be illustrated using the following example: suppose that a prediction request 130 was received. The prediction request 130 requests predictions for a population including patients who are forty-five-year-old or older, and who underwent a particular medical treatment that caused in the patients a 10% reduction of total cholesterol and a 5% reduction in systolic blood pressure. Upon receiving the prediction request, processing apparatus 110 may attempt to predict the effects of the particular medical treatment, long term benefits of the treatment, long term risks of the treatment, a probability that the patients who took a particular medication would experience myocardial infarctions, or probabilities of some other events. Processing apparatus 110 may determine one or more optimum patient populations for the particular treatment scenario, specified in the prediction request. Further, processing apparatus 110 may also allow determining one or more optimum treatment scenarios for the simulated population that is specified by a population definition in the prediction request.

Interface handling unit 115 may be configured to receive, from request processor 116, prediction response data, obtained by request processor 116 in response to receiving a prediction request 130. Upon receiving the prediction response data, interface handling unit 115 may process the prediction response to generate a prediction 140. For example, interface handling unit 115 may resolve any compatibility issues that may occur between the data format in which the prediction response data is provided and the data format in which the prediction 140 may be provided to requestor computer 120.

In an embodiment, request processor 116 is coupled to the processor 119, and is configured to retrieve from database 150 a response dataset that maps, based on a healthcare simulation model, a plurality of combinations of input variables to response variables. The response dataset may be one of a plurality of datasets 157 stored in database 150, generated by a healthcare model.

Generating a plurality of datasets 157 may be performed in advance and offline. Datasets 157 may be made readily available at any time that a prediction request 130 is received by processing apparatus 110. Details related to generating the datasets 157 and using the model execution unit 112 are provided below.

Request processor 116 may also be configured to parse a prediction request 130 to identify a population definition and one or more healthcare treatment criteria. In an embodiment, a population definition may define a particular patient population for whom the prediction of the effects of a particular treatment is sought. The one or more healthcare treatment criteria may specify the particular treatment for which the effects on the particular patient population are sought.

Request processor 116 may also be configured to invoke a converger unit 117 and request that the converger unit 117 identify a plurality of simulated patients in a response dataset that match the population definition included in a prediction request. For example, if a population definition indicates a population comprising males, who 45 years old or older, then request processor 116 may request that the converger unit 117 identify in the retrieved dataset those simulated patients who are males and who are at least 45 years old.

Converger unit 117 may cooperate with dataset management unit 114 to identify a certain group of simulated patients. For example, upon receiving a population definition and a response dataset from request processor 116, converger unit 117 may request, from dataset management unit 114, simulated data 159 that comprises data for simulated patients. Converger unit 117 may also execute an algorithm that uses the population definition provided by request processor 116, and maps the population definition to a subset of the simulated patient data in the response dataset.

In an embodiment, converger unit 117 executes a fast running algorithm. The fast running algorithm may be designed for execution in a relatively efficient and optimized way. For example, the algorithm may be designed to return results in a timeframe that is acceptable to typical users. Examples of acceptable timeframes may include ten (10) seconds. In other implementations, depending on the requirement specification provided to processing apparatus 110, the timeframe may be longer or shorter than ten seconds.

Response surface generator 118 is configured to determine a response surface that meets the constraints specified in a prediction request 130. Response surface generator 118 may use a response dataset retrieved for simulated patients and one or more response variables that are functions of one or more input variables for which the response dataset was generated. In an embodiment, the response surface may be generated in response to receiving a prediction request 130 at processing apparatus 110. The response surface may be generated dynamically, in approximately real-time, and as part of the on-the-fly online processing.

A response surface may be generated using a variety of approaches. For example, response surface generator 118 may generate a response surface by generating a polynomial model based on a response dataset retrieved for the simulated population. According to this approach, response surface generator 118 may map one or more healthcare treatment criteria, included in a prediction request, to a function of one or more input variables for which the response dataset was generated, and fit the generated polynomial model into one or more factorial variables for the response dataset. The obtained response surface reflects prediction results sought in the received prediction request.

In an embodiment, response surface generator 118 determines prediction response data based on a response surface, but not on a healthcare model itself. The predicted response data approximates the simulation results that would be obtained if the information from a prediction request was input to the healthcare model and a simulation with the healthcare model was performed directly. While the predicted response data and healthcare model outputs are effectively identical, the predicted response data can be obtained in real-time while the healthcare model simulation usually requires several hours to run.

In an embodiment, a model execution unit 112 is configured to perform a healthcare model simulation to obtain one or more response datasets that can be used to predict effects that certain treatments may have on certain populations of patients. In embodiment, model execution unit 112 generates the response datasets offline and stores the datasets as datasets 157 in database 150.

Model execution unit 112 may generate a response dataset by performing a variety of statistical experiments, in which input variables are varied in a systematic way, and in which by varying the input variables, output variables are derived from the input variables. For example, model execution unit 112 may generate a response dataset by performing a factorial design of experiments and simulating the experiments. In the simulating experiments, one or more input variables are varied in a systematic way. By varying the input variables, models of one or more response variables are derived for the input variables.

Examples of input variables may include population-related data, treatment-scenario data and any other data related to measures of effects the medical treatment may have on patient population. In particular, the plurality of input variables may include treatment data, biomarkers data, disease risk data and population data.

Examples of response variables may include disease event rates, risk data for various medical conditions, including risk data for myocardial infarction, stroke, organ failure, or other risk data. The response variables may also include medical costs, life years, mortality rate and other information possibly outputted by the healthcare model.

In an embodiment, upon receiving a plurality of combinations of input variables, each of which comprises healthcare model related data, a particular healthcare model is selected and executed. The selected particular healthcare model accepts a plurality of combinations of input variables, and generates a response dataset. The response dataset may be generated by performing one or more healthcare model simulations using the particular healthcare model, and by varying the input values in the plurality of combinations of input variables. The input values may be varied using for example, a design of experiments. Details of the design of experiments and a working example of the design simulation are provided below.

Processor 119 may be configured to execute commands of the units 112-118, and facilitate communications between the units 112-118, database 150 and requestor computer 120, as well as execute other stored program instructions for other purposes.

3.0 Generating Response Dataset

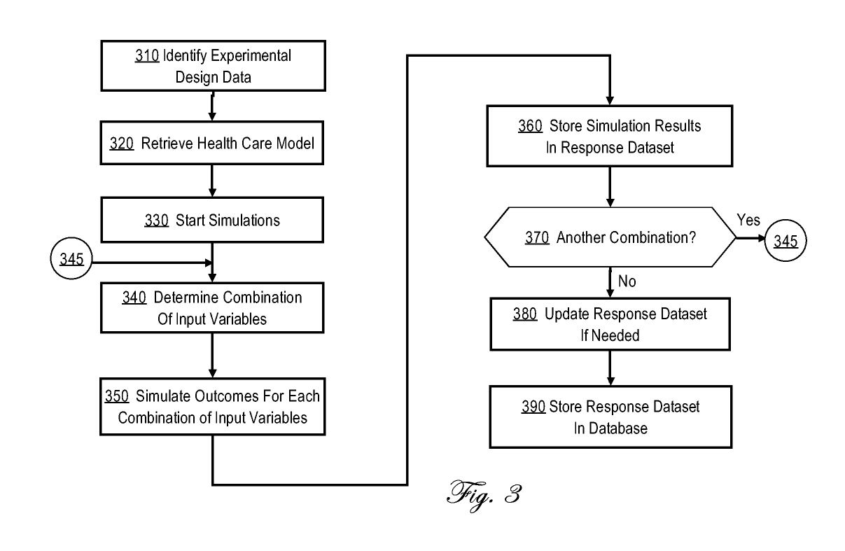

FIG. 3 illustrates an example method for generating a response dataset. This process may be performed offline and prior to receiving a prediction request.

In step 310, a set of input variables to be mapped are selected, and an experimental design is identified. Identifying the experimental design may involve defining one or more combinations of input variables. Input variables are input parameters to a healthcare model. Values of the input variables will be systematically varied over some domain within a healthcare model according to an experimental design. Examples of the input variables include parameters specifying treatment with particular medications, such as aspirin or other drugs, parameters specifying changes in biomarkers, parameters specifying changes in risks in particular medical conditions, and other parameters. The input variables may reflect ranges in various parameters, values of which may be varied when the response dataset is generated, and values of which may be varied by the user who submit prediction requests.

In step 320, a healthcare model is retrieved. Various models may be applicable in this step. One of the examples of a healthcare model may be a Java software application configured to perform simulation on various combinations of values of input variables. For example, a healthcare model may systematically vary values of the input variables over some domain within a healthcare model design, generate response values for each of the combination of the input variables, and store the response values for each of the combinations.

In step 330, simulation of a series of computer experiments according to a selected experimental design starts.

In step 340, one of many combinations of values for the input variables is determined. A particular combination of the input variables reflects a treatment scenario expressed in the form of input variables to the healthcare model.

In step 350, a simulation is performed with a healthcare model for the particular combination of the input variables. In an embodiment, the simulation includes generating response values for the particular combination values of the input variables. In this step, a significant amount of data for a huge patient population represented in a design matrix is processed. For example, the processing may involve simulating output data for all possible individuals with the particular set of input variables, and the response variables may be used in simulating the output for each of the individuals. In run-time, a subgroup of individuals is selected from the group for which the simulation was performed. By processing the significant amount of data, the system will obtain response values that may provide answers to nearly all possible prediction requests that may be received later on at the run-time. By processing and simulating such a vast amount of data, the system will derive information that in the run-time may be readily available to server as answers to nearly all possible prediction requests.

In the course of the simulations, the values of response variables are determined for the values of the combination of the input variables for which the simulation is executed. The values of the response variables are outputs from the healthcare model and depend on the values of the combination of the input variables. Examples of the response variables may include disease event rates and other health-related statistical information.

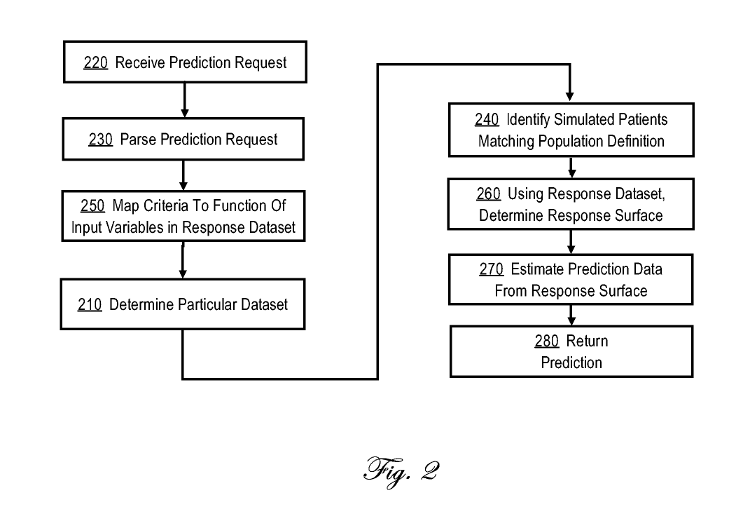

In step 360, simulation results are stored in a form of a response dataset. If one simulation has been executed for a particular combination of input variables, then in step 360, the simulation results obtained in step 350 are used to create a response dataset. However, if the simulation has been repeated for two or more combinations of input variables, and a response dataset for the particular input variables has been already created, then in step 360, the simulation results obtained in step 350 are used to update the response dataset. Later on, at run-time, a response dataset may provide estimates to prediction requests received by a processing apparatus. The process of deriving the estimates from the response datasets in described in FIG. 2, below.

In step 370, it is determined whether another combination of the input variables may be derived. If another combination of the input variables may be derived, then the simulation process of steps 340-360 is performed for another combination.

However, if the ability to generate a new, unique combination of the input variables has been exhausted, then the process proceeds to step 380, in which, if needed, the generated response dataset may be updated. For example, the response dataset may be converted to an easy-to-store database file, partitioned into a file containing easy-to-search partitions, or processed by compressing the data included in the response dataset.

In step 390, the response dataset is stored in a database. The database may be implemented in any type of a relational database and may be implemented in any type of a server or other storage device. The response dataset may be stored locally or remotely with respect to a processing apparatus 110.

4.0 Generating Prediction Response Data

FIG. 2 illustrates an example method for generating prediction response data.

In step 210, a prediction request is received at a processing apparatus. The prediction request may be received from a user, a patient, a healthcare professional, a healthcare service provider, or any other entity that uses the presented approach. The prediction request may be received via a web browser and may contain data entered by the user into the web browser page.

A prediction request may be a query issued to a processing apparatus described in FIG. 1, and may comprise various types of information. For example, a prediction request may comprise a request to provide real-time estimates of certain health risks that may be anticipated if individuals in a particular patient population undergo a particular medical treatment within a certain time period. Examples of such requests may include a request to provide real-time estimates of five (5) year-risks of myocardial infarction associated with hypothetical changes in total cholesterol levels and hypothetical changes in systolic blood pressure levels in a simulated group of patients of a certain age.

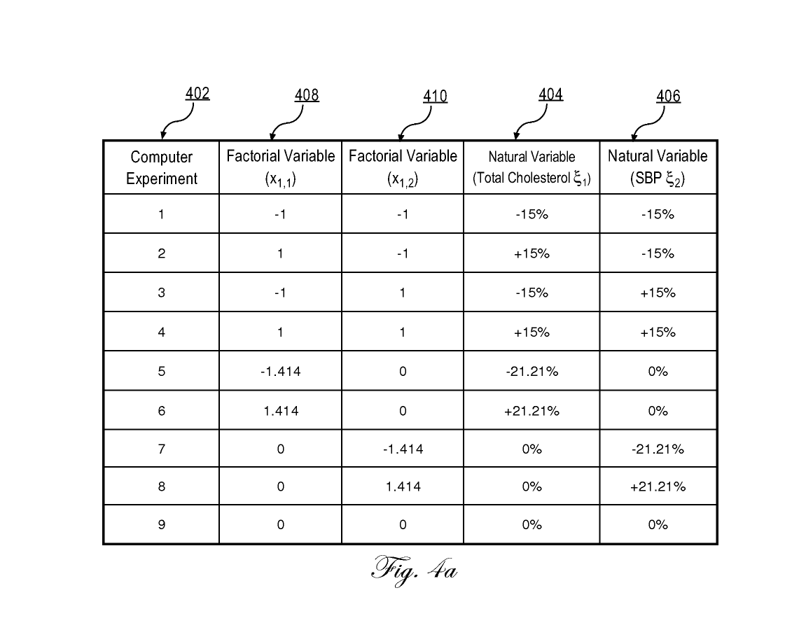

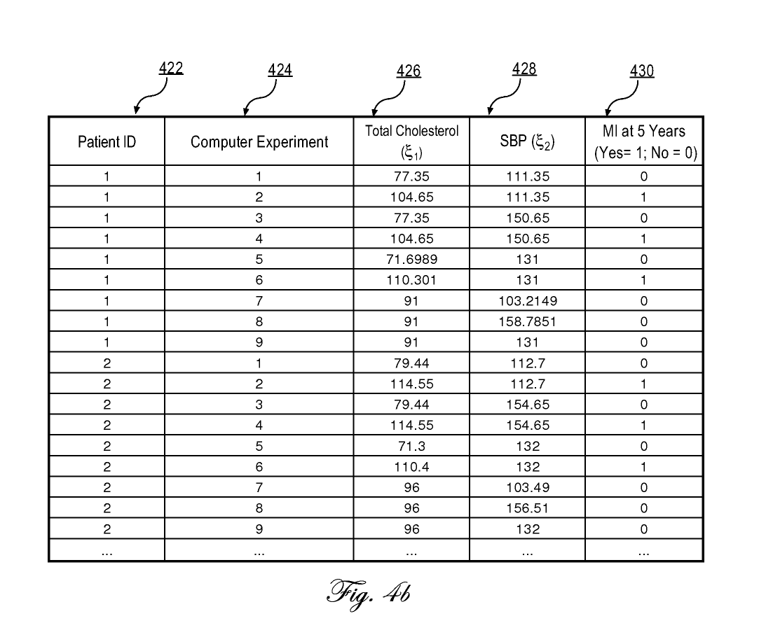

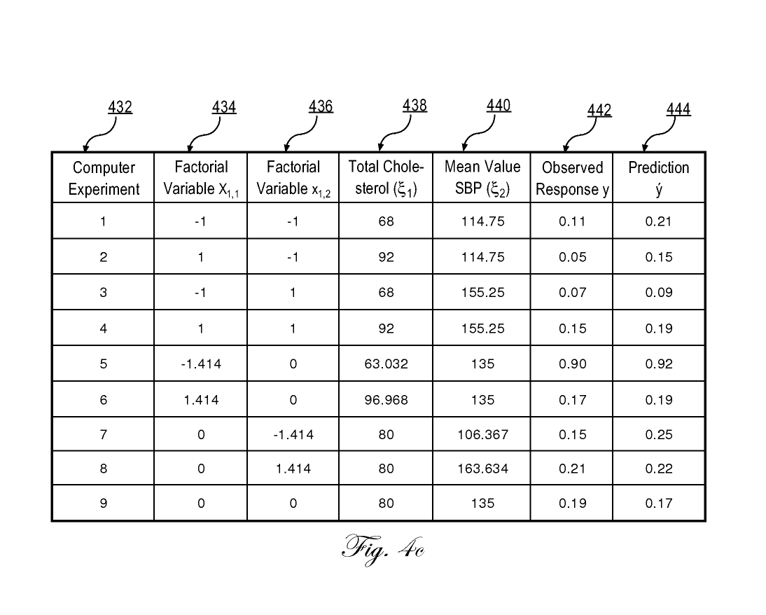

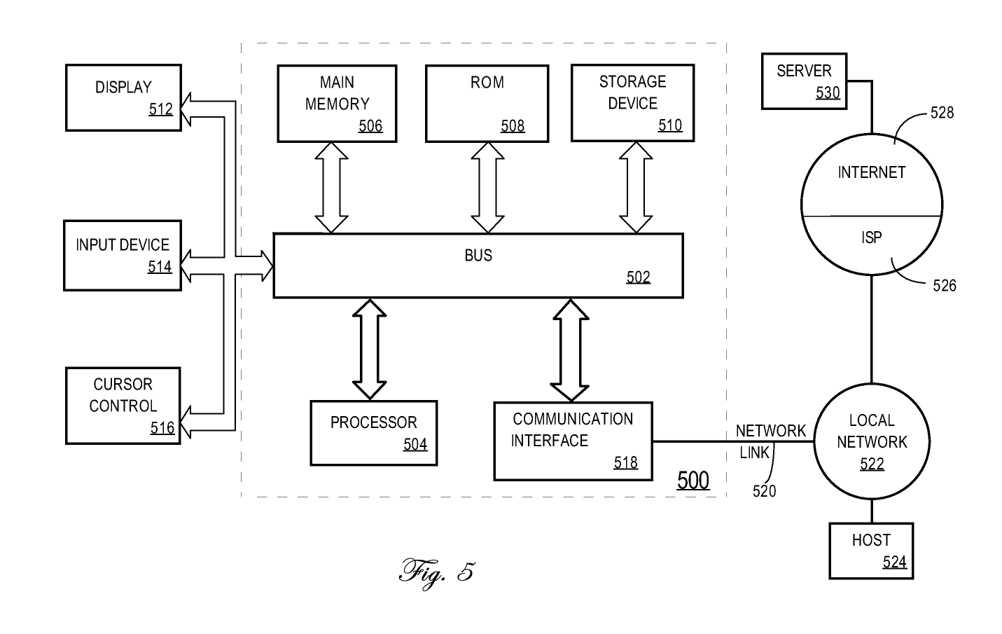

In an embodiment, a prediction request comprises a population definition and one or more healthcare treatment criteria that specify a particular treatment scenario. The population definition defines a particular subset of simulated patients for which real-time estimates are requested. The one or more healthcare treatment criteria specify a particular treatment scenario for which health risks are requested, such as effects on risk factors, biomarkers, and disease risks. For example, if a prediction request is to provide real-time estimates of five (5) year-risks of myocardial infarction associated with a certain change in total cholesterol levels and a certain change in blood pressure levels for male patients who are at least 45 years old, then a population definition specifies male patients who are at least 45 years old, and healthcare treatment criteria specified the treatment details specified in the request. The five year risks of myocardial infarction given the treatment could then be contrasted with those in an appropriate control scenario. A base case or control case may also be computed in advance. This will be explained in detail in FIG. 4-5, below.

In step 230, a received prediction request is parsed and elements of the prediction request are identified. In the course of parsing the received prediction request, a population definition and one or more healthcare treatment criteria may be identified in the request. As described above, the population definition specifies a particular subset of simulated patients, and the one or more healthcare treatment criteria specify a particular treatment, effects of which are the object of the prediction request.

In step 250, one or more healthcare treatment criteria are mapped to a function of the input variables in a response dataset. The one or more healthcare treatment criteria are the criteria included in a received prediction request. The one or more healthcare treatment criteria specify a treatment scenario for which a prediction of health risks is sought.

A response dataset is a dataset generated and stored offline. The response dataset may be generated in advance and may be stored in the database before prediction requests are received from a user. The details of generating and storing a response dataset were provided in FIG. 3, above.

In step 210, based on the mapping of the one or more healthcare treatment criteria to a function of the input variables in a response dataset, as described in step 250, a particular response dataset is determined. The particular dataset reflects the information tailored for the treatment scenario for which the prediction of health risks is sought in the prediction request.

In step 240, a subset of simulated patients who match the population definition is identified. For example, if the population definition included in a received prediction request specifies male patients who are at least 45 years old, then, using the population definition, a subset of simulated patients in the response dataset that match the population definition is identified. This step may be performed by executing a fast running algorithm that takes the population definition received in the prediction request, and maps the definition to a subset of the simulated patients in the response dataset. The process may be executed by converger unit 117 of FIG. 1.

In step 260, using the response dataset, a response surface is determined for a subset of simulated patients identified by the converger unit 117. For example, once a subset of simulated patients for the response dataset is determined, a response surface may be determined by fitting a polynomial into the response dataset data. Continuing with the previous example, if a prediction request asks for real-time estimates of five-year-risks of myocardial infarction when administering a particular medication to a certain patient population caused a particular change in total cholesterol levels, then a response surface may reflect estimates for the myocardial infarction risk for the particular patient population and for the particular change in the total cholesterol levels.

A response surface may be obtained using a variety of methods. Non-limiting examples of such methods include a polynomial surface fitting, various interpolation methods, and other methods. In an embodiment, a response surface is obtained by fitting a polynomial model to factorial variables and the response dataset. Examples of the polynomial models may include any n^{th} degree model, such as a quadratic model, a cubic model, a quartic model and any other model. In simple cases, a linear model may be used. In more complex cases, a quadratic or cubic model may be recommended.

In an embodiment, a response surface can be used in real-time to obtain estimates of the healthcare model output for some combination of input variables and for a specified population, provided in a prediction request.

A response surface may be generated on-the-fly because generating a response surface is usually computationally efficient. For example, each time a prediction request is received by a processing apparatus, a response surface that satisfies the request specified in the prediction request is generated. As requestor computers submit prediction requests, the process responds interactively and generates a response surface for each received prediction request.

In step 270, prediction response data is estimated from a response surface. Estimating the prediction response data from a response surface may comprise determining estimate point data from the response surface that satisfy a received prediction request. An estimate point is a point on the response surface, and determining estimate point data includes evaluating the response surface model, such as a polynomial, at the point corresponding to the input variables provided in the prediction request.

The estimation may be performed using various data interpolation techniques. Further, the estimation may utilize uncertainty quantification error margins and various statistical approaches.

In step 280, a prediction response data is provided to a user. The prediction response data may comprise data estimated from a response surface, derived as described in step 270. The prediction response data may be displayed in a web browser, which user launched on his computer, and from which the user issued a prediction request. For example, if a user launched a web browser on a requestor computer 120, as depicted in FIG. 1, then the prediction response data may be displayed for the user in the same web browser on the requestor computer 120. The prediction response data may be displayed on a separate web page, or as part of the same web page from which the user sent the prediction request. The prediction response may be presented in a form of a table, a graph, a spreadsheet, or any other form.

One of the objectives for implementing the approach illustrated in FIG. 2 is to implement the approach in such a way that a response time for receiving a prediction response data from the system is as small as possible. One of the advantages of the presented approach is that response datasets are generated offline, and thus are readily available when a prediction request is received. Each time a prediction request is received, the system may retrieve a ready-to-use response dataset, and avoid generating one from scratch. Since generating the response dataset is usually very time-consuming and resource-demanding, generating the response datasets in advance and even outsourcing the dataset generation speeds up the process of handling prediction requests.

A response time may also be optimized by employing a fast converger in the process of generating a response to a prediction request. In an embodiment, a population selection algorithm, executed in step 240, may be implemented as a fast-running algorithm, also referred to as a fast converger. Application of the fast converger may significantly shorten the time for identifying a subset of simulated patients that match a population definition provided in a prediction request.

Efficient implementations of other components of the presented system may also positively contribute to reducing the system total response time. For example, some or each of steps 250-270, described below, may be executed by fast-running algorithms, and execution of such fast-running algorithms may decrease the total response time to some degree.

5.0 Example of Generating Response Datasets

This section describes an example of generating response datasets, which later may be used in generating answers to prediction requests. For clarity, the example refers to generating a response dataset that contains information related to myocardial infarctions (MI); however, other embodiments may generate response datasets for any other healthcare condition, disease, intervention, encounter, or event.

In an embodiment, a response dataset is represented in multiple data tables. A response dataset is generated for future use by an interactive system that provides estimates to prediction requests.

Generating a response dataset may start with determining a quantity of input variables. For example, assume that two input variables will be used, and the two input variables are: a total cholesterol (TC) variable and a systolic blood pressure (SBP) variable. The variables are referred below to as ξ₁ and ξ₂. In this example we will employ a design of experiments suitable for constructing a 2^{nd} order response surface.

There is a wide array of possible designs that can be used, and the disclosed approach is not limited to any particular design. One of such designs may include a central composite 2² design.

In the next step, a range of changes in both TC and SBP is selected. The range of changes indicates the range in changes in both TC and SBP over which the predicted 5-year risk of MI may be mapped. In an embodiment, the range may be determined as +/−15%. Hence, in the course of the simulation described below, values of TC and values of SBP may vary by +/−15%, respectively.

A response surface maps MI risks versus relative changes in both TC and SBP within a +/−15% range. A center point of the response surface may correspond to a simulated population's baseline values of TC and SBP. In this context, the simulated population's baseline values are determined for a scenario when no medical treatment is administered to the patients. This can be used as a comparator to compare for example, relative and absolute reductions with base values.

In the next step, the input variables ξ₁ and ξ₂ are transformed into dimensionless factorial variables x, using the transformation:

$${x}_{1 i} = \frac{{ξ}_{1 , i} - {Δ}_{1}}{{Δ}_{1}}$$

Where x_{1,i} is the first transformed factorial variable associated with the i^{th} computer experiment of the design, ξ_{1,i} is the first input variable expressed in its natural units, and Δ₁ is the half range of the first input variable expressed in its natural units, such as 15% of from a center point value. In an embodiment, the usable range of the factorial variables is [−1, 1]. The response surface will only be able to provide estimates over the specified range. Therefore, at run-time, the estimates for prediction requests that have +/−15% change or less in TC and/or SBP can be returned.

In an embodiment, the risks of MI are simulated using the healthcare model and the levels of the input variables dictated by the experimental design. For example, the 5-year risk of MI may be simulated for 6,000,000 adults who are 45 years old or older, and for each combination of input variables specified by the 2² central composite factorial design.

FIG. 4a illustrates an example of a matrix generated using an experimental design approach. In particular, FIG. 4a depicts an example 2² central composite factorial design applied to changes in TC and SBP. Values of the input variables and the results derived for the input variables by executing several computer experiments are depicted in respective columns and rows of the table depicted in FIG. 4a. In an embodiment, column 402 contains a computer experiment identifier, column 408 contains values for a factorial variable x_{1,1}, column 409 contains values of a factorial variable x_{1,2}, column 404 contains values of a natural TC (ξ₁), and column 406 contains values of a natural SBP variable (ξ₂),

In the table depicted in FIG. 4a, a center point of the range to be mapped corresponds to a factorial variable value of “0.” The variations in the input variables for each of the computer experiments are expressed as relative changes that can be applied to each simulated patient.

FIG. 4b illustrates an example of a database table generated using an experimental design approach. In particular, FIG. 4b illustrates an example database table showing the first ten (10) rows generated using the factorial design applied to changes in TC and SBP. The table contains nine (9) rows for a particular patient in a particular patient population. Each of the rows corresponds to one of nine experiments executed as described above. In an embodiment, the database table would contain a large number of simulated patients.

In FIG. 4b, column 422 contains a patient identifier, column 424 contains a computer experiment identifier, column 426 contains values of a TC variable (ξ₁), column 428 contains values of a SBP variable (ξ₂), and column 429 contains an indication whether MI may potentially occur after five (5) years of the medical treatment specified by the input variables. In particular, if the indication in column 429 is represented as “1,” then the healthcare model predicted that the individual would have an MI during the time period of five (5) years. However, if the indication in column 429 is represented as “0,” then the healthcare model predicted an MI would not occur when the medical treatment specified by the input variables is administered to the certain patient population during the five-year-time-period.

In an embodiment, a database table such as the table depicted in FIG. 4b may be generated offline and in advance before the table is used online in generating responses to prediction requests. Due to the size of the database table, generating the table may be time-consuming and resource-demanding.

In an embodiment, database tables (response datasets) may contain a large number of records, reflecting a large number (millions) of simulated individuals, stored in a high performance relational database that facilitates the access, sub-selection, and aggregation of the results.

One of the advantages of the presented approach is the ability to provide answers to a larger quantity of questions in a working day than it is possible using conventional approaches. For example, because the system provides predictions to the prediction requests in almost real time, sending prediction requests and receiving predictions usually takes a short period of time, and within a short period of time, the user may refine his requests and consider various treatment options. The fact that a user can ask questions and receive immediate responses allows the user to obtain a vast amount of information in a short period of time. In contrast, in a conventional approach, a user usually waits a long time before he can receive an answer to his questions. In some conventional implementations, a user may have to wait a day or two before the system provides an answer to even a simple, treatment related question.

6.0 Example of Generating Prediction Response Data

An example of an interactive process for generating a prediction response to a prediction request is now described. The interactive process is implemented and configured to generate responses to receive prediction requests efficiently and quickly.

For clarity, the example described in this section refers to processing a specific prediction request; however, the example should not be viewed as limiting in any way.

In an embodiment, prediction response data is generated to provide an answer to a received prediction request. For clarity of explanation, it is assumed that the prediction request inquired for an estimate of the reduction in MI risk associated with decreasing total cholesterol by 10% and decreasing SBP by 5%, for a population of patients who are 45 years old or older.

In an embodiment, a user may launch a web browser on a requestor computer, and enter prediction request information on a web page generated by the web browser. Alternatively, the user may enter the prediction request information via a command line, an email, or any other form of computer-generated interface acceptable by the system.

In an embodiment, a user submits a prediction request as a problem statement by typing into the system a request in a form of a sentence. For example, a user may enter “estimate the reduction in the risk of MI associated with decreasing total cholesterol by 10% and decreasing SBP by 5%, in the population of US adult patients with age >=45 years”.

Upon receiving a prediction request, the prediction request may be parsed to identify a population definition and one or more treatment criteria. In the example provided above, the population definition may comprise “the population of US adult patients with age >=45 years,” while the one or more treatment criteria may comprise “estimate the reduction in the risk of MI associated with decreasing total cholesterol by 10% and decreasing SBP by 5%.”

Using a population definition, a subset of simulated patients may be identified. For example, if a response dataset was generated for a simulated population of individuals who are at least 25 years old, then using the population definition indicating the patients who are older than 45, a subset of the simulated population may be identified to match the requirements set forth in the population definition.

In an embodiment, selecting a subset of the simulated population is performed by obtaining a set of patients who satisfy the population definition. Each patient may have a patient identifier (“patient ID”). Each patient may have associated an age-parameter that indicates the age of the patient. Using the patient identifiers and the age-parameters, a subset of simulated patients may be determined. For example, if the patient definition specified a population of patients who are at least 45, then the subset of simulated patients comprises those rows in the response dataset that corresponds to the patients who are indeed 45 or older.

In an embodiment, a subset of the simulated population may be further restricted through a convergence process. In an embodiment, a convergence process is a numerical optimization procedure that seeks to match the characteristics of the subpopulation with stated goals, such as for example, finding a subpopulation with a mean age of 64.5 years at baseline. Convergence may be performed by numerically minimizing a similarity metric describing how “far” the subpopulation statistics (typically means and variances) are from the goals stated by the user. Typically, the process involves minimizing the objective function φ of the form:

$${\overline{ξ}}_{1} = \frac{1}{N} {\sum }_{i = 1}^{N} {ξ}_{j , i}$$

$$ϕ = {\sum }_{j = 1}^{k} {w}_{j} \frac{( {\overline{ξ}}_{i} - {μ}_{j} )}{{σ}_{j}^{2}}$$

Where ξ̅ⱼ represents the mean of the j^{th} characteristic being converged on, N represents the number of individuals in the subpopulation, j in the second equation represents the number of characteristics being converged on, wⱼ represents the numerical weight of the j^{th} characteristic (default being unity), μⱼ represents the desired mean of the j^{th} characteristic, and σⱼ² represents the variance of the j^{th} characteristic in the population.

In an embodiment, using a response dataset and a subset of the simulated population, one or more aggregate values of the model inputs for the patient population for all experiments (rows) of the design are computed.

Aggregate values may be computed in a variety of ways. For example, for the patient population, mean values of the input variables and output responses may be computed for each computer experiment of the design. More specifically, for the input values for each computer experiment of the design, a mean value of TC and SBP, at baseline or any other time point, for all individuals in the subpopulation may be computed.

In an embodiment, in addition to computing aggregate values, more sophisticated processing and analysis may be also performed. For example, a Kaplan-Meier-survival approach may be employed to perform a more refine analysis.

In an embodiment, aggregated values computed as described above may be stored in a table, such as the table depicted in FIG. 4c.

FIG. 4c illustrates an example of computer experiments and observed responses associated with the 2² central composite factorial design for a particular subpopulation. In FIG. 4c, column 432 contains a computer experiment identifier, column 434 contains values of a factorial variable x_{1,1}, column 436 contains values of a factorial variable x_{1,2}, column 438 contains values for mean values of natural variables TC ξ₁, column 440 contains values for mean values of natural variables SBP ξ₂, column 442 contains values for observed response for the subpopulation of 5-year incidence in myocardial infarction, and column 444 contains prediction values ŷ

In an embodiment, using aggregate values, including observed response associated with a particular factorial design, response surface coefficients are computed for the subpopulation using least squares regression. In this example, a response surface may provide an estimate of the 5-year MI incidence given any values of TC and SBP change (within the mapped region) for the subpopulation.

In an embodiment, a response surface is generated. A response surface is a map over a pre-specified range of input variables, and relates input variables and output variables of some process or function. In the present context, a response surface relates input variables (such as baseline weight) to output variables (such as 5-year risk of MI) for a particular population of patients.

A response surface may be obtained by fitting a polynomial model to response dataset. A simple functional form, such as a polynomial, is commonly used to estimate the response surface, and the coefficients are typically obtained by least squares estimation.

Estimates of the output variables corresponding to particular values of the input variables can then be obtained from the response surface model rather than the full healthcare model. Evaluating the polynomial model is much less computationally expensive than obtaining estimates directly from the underlying full healthcare model.

In an embodiment, a response surface is generated by fitting a second order model (second order polynomial) using the factorial variables. An example of such a model is:

y=β₀+β₁x₁+β₂x₂+β₁₁x₁²+β₂₂x₂²+β₁₂x₁x₂+ε

where ε represents the fitting error.

In an embodiment, fitting the model is performed by creating an extended design matrix, adding a column of ones for the center point, as follows:

$$X = \begin{matrix} & {x}_{1} & {x}_{2} & {x}_{1}^{2} & {x}_{2}^{2} & {x}_{1} {x}_{2} \\ 1 & - 1 & - 1 & 1 & 1 & 1 \\ 1 & 1 & - 1 & 1 & 1 & - 1 \\ 1 & - 1 & 1 & 1 & 1 & - 1 \\ 1 & 1 & 1 & 1 & 1 & 1 \\ 1 & - 1.414 & 0 & 1.999396 & 0 & 0 \\ 1 & 1.414 & 0 & 1.999396 & 0 & 0 \\ 1 & 0 & - 1.414 & 0 & 1.999396 & 0 \\ 1 & 0 & 1.414 & 0 & 1.999396 & 0 \\ 1 & 0 & 0 & 0 & 0 & 0\end{matrix}$$

$$y = \begin{matrix}0.11 \\ 0.05 \\ 0.07 \\ 0.15 \\ 0.9 \\ 0.17 \\ 0.15 \\ 0.21 \\ 0.19\end{matrix}$$

and estimating the parameters, βⱼ, as b=(X′X)⁻¹X^{T}y, the standard matrix formulation of least squares, where T indicates transpose and ⁻¹ indicates matrix inverse.

In an embodiment, for any value of the input variables TC and SBP, the natural variables are transformed to the factorial variables, x₁, and x₂, and the estimated MI incidence is computed as:

ŷ=Xb.

In a next step, the changes in TC and SBP provided by the user are transformed to factorial variables, and the response surface is evaluated for:

x1=−0.666 . . .

x2=−0.333 . . .

The x1 and x2 values are plugged into the response surface model with the least squares estimates of the coefficients b:

ŷ*=b₀−0.666b₁−0.333b₂+b₁₁(−0.666)²+b₂₂(−0.333)²+b₁₂(−0.666)(−0.333)

In the next step, the estimated change in MI risk associated with a 10% reduction in TC and 5% reduction in SBP relative to baseline is determined as:

ŷ*=ŷ_{center point}

The results obtained using the approach outlined above may be reported to the user. The results are referred to herein as prediction response data. The prediction response data may be provided to the user via a user interface, generated by a web browser or any other software application designed to interactively communicating with the user.

7.0 Implementation Mechanics—Hardware Overview

FIG. 5 is a block diagram that illustrates a computer system 500 upon which an embodiment of the invention may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for implementing the techniques described herein. According to an embodiment of the invention, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operate in a specific fashion. In an embodiment implemented using computer system 500, various machine-readable media are involved, for example, in providing instructions to processor 504 for execution. Such a medium may take many forms, including but not limited to storage media and transmission media. Storage media includes both non-volatile media and volatile media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution. In this manner, computer system 500 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
receiving a prediction request that comprises a population definition and one or more healthcare treatment criteria specifying a treatment scenario;
in response to receiving the prediction request, performing in a real-time:
parsing the prediction request to identify the population definition and the one or more healthcare treatment criteria;
mapping the one or more healthcare treatment criteria to a function of one or more input variables to determine a particular dataset, from a plurality of datasets;
based, at least in part, on the population definition and the particular dataset, determining a response surface;
determining prediction data by estimating, using the response surface which approximates the healthcare simulation model, simulation results that using the healthcare simulation model would yield;
returning the prediction data;
wherein the method is performed by one or more computing devices.

2. The method of claim 1, wherein the response surface is generated according to an experimental design.

3. The method of claim 1, wherein the prediction request comprises a request to predict effects of the treatment scenario on individuals specified by the population definition.

4. The method of claim 2, wherein the experimental design is a matrix describing a set of experiments and simulations performed using any one of a plurality of healthcare models.

5. The method of claim 2, wherein the response surface allows:
comparing effects of the treatment scenario, specified by the one or more healthcare treatment criteria, on individuals specified by the population definition;
determining one or more optimum patient populations for the treatment scenario;
determining one or more optimum treatment scenarios for the individuals specified by the population definition.

6. A method comprising:
receiving a plurality of combinations of input variables, each of the plurality of combinations of input variables comprising health data;
retrieving, from a plurality of healthcare models, a particular healthcare model that accepts the plurality of combinations of input variables;
for each of the plurality of combination of input variables:
generating a response dataset by performing one or more healthcare model simulations using the particular healthcare model and the input variables by varying values of the input variables using an experimental design, and determining values of response variables;
storing the response dataset in a database;
wherein the one or more healthcare model simulations comprise performing a statistical analysis;
wherein the plurality of combinations of input variables comprises any one of: population-related data and treatment-scenario data;
wherein the method is performed by one or more computing devices.

7. The method of claim 6, wherein the plurality of combinations of input variables comprises any one data of: treatment data, biomarkers data, disease risk data and population data; wherein the response variables comprise any one data of: disease event rates and other statistical information.

8. A non-transitory computer-readable storage medium storing one or more sequences of instructions which, when executed by one or more processors, cause the one or more processors to perform:
receiving a prediction request that comprises a population definition and one or more healthcare treatment criteria specifying a treatment scenario;
in response to receiving the prediction request, performing in a real-time:
parsing the prediction request to identify the population definition and the one or more healthcare treatment criteria;
mapping the one or more healthcare treatment criteria to a function of one or more input variables to determine a particular dataset, from a plurality of datasets;
based, at least in part, on the population definition and the particular dataset, determining a response surface;
determining prediction data by estimating, using the response surface which approximates the healthcare simulation model, simulation results that using the healthcare simulation model would yield;
returning the prediction data.

9. The non-transitory computer-readable storage medium of claim 8, wherein the response surface is generated according to an experimental design.

10. The non-transitory computer-readable storage medium of claim 9, wherein the prediction request comprises a request to predict effects of the treatment scenario on individuals specified by the population definition.

11. The non-transitory computer-readable storage medium of claim 8, wherein the experimental design is a matrix describing a set of experiments and simulations performed using any one of a plurality of healthcare models.

12. The non-transitory computer-readable storage medium of claim 8, wherein the response surface allows:
comparing effects of the treatment scenario, specified by the one or more healthcare treatment criteria, on individuals specified by the population definition;
determining one or more optimum patient populations for the treatment scenario;
determining one or more optimum treatment scenarios for the individuals specified by the population definition.

13. A non-transitory computer-readable storage medium storing one or more sequences of instructions which, when executed by one or more processors, cause the one or more processors to perform:
receiving a plurality of combinations of input variables, each of the plurality of combinations of input variables comprising health data;
retrieving, from a plurality of healthcare models, a particular healthcare model that accepts the plurality of combinations of input variables;
for each of the plurality of combination of input variables:
generating a response dataset by performing one or more healthcare model simulations using the particular healthcare model and the input variables by varying values of the input variables using an experimental design, and determining values of response variables;
storing the response dataset in a database;
wherein the one or more healthcare model simulations comprise performing a statistical analysis;
wherein the plurality of combinations of input variables comprises any one of:
population-related data and treatment-scenario data.

14. The non-transitory computer-readable storage medium of claim 13, wherein the plurality of combinations of input variables comprises any one data of: treatment data, biomarkers data, disease risk data and population data; wherein the response variables comprise any one data of: disease event rates and other statistical information.

15. An apparatus, comprising:
one or more processors;
a request processor coupled to the one or more processors, and configured to perform:
receiving a prediction request that comprises a population definition and one or more healthcare treatment criteria specifying a treatment scenario;
in response to receiving the prediction request, performing in a real-time:
parsing the prediction request to identify the population definition and the one or more healthcare treatment criteria;
mapping the one or more healthcare treatment criteria to a function of one or more input variables to determine a particular dataset, from a plurality of datasets;
based, at least in part, on the population definition and the particular dataset, determining a response surface;
determining prediction data by estimating, using the response surface which approximates the healthcare simulation model, simulation results that using the healthcare simulation model would yield;
returning the prediction data.

16. The apparatus of claim 15, wherein the response surface is generated according to an experimental design.

17. The apparatus of claim 16, wherein the prediction request comprises a request to predict effects of the treatment scenario on individuals specified by the population definition.

18. The apparatus of claim 15, wherein the experimental design is a matrix describing a set of experiments and simulations performed using any one of a plurality of healthcare models.

19. The apparatus of claim 15, wherein the response surface allows:
comparing effects of the treatment scenario, specified by the one or more healthcare treatment criteria, on individuals specified by the population definition;
determining one or more optimum patient populations for the treatment scenario;
determining one or more optimum treatment scenarios for the individuals specified by the population definition.

20. An apparatus, comprising:
one or more processors;
a model executing unit coupled to the one or more processors, and configured to perform:
receiving a plurality of combinations of input variables, each of the plurality of combinations of input variables comprising health data;
retrieving, from a plurality of healthcare models, a particular healthcare model that accepts the plurality of combinations of input variables;
for each of the plurality of combination of input variables:
generating a response dataset by performing one or more healthcare model simulations using the particular healthcare model and the input variables by varying values of the input variables using an experimental design, and determining values of response variables;
storing the response dataset in a database;
wherein the one or more healthcare model simulations comprise performing a statistical analysis;
wherein the plurality of combinations of input variables comprises any one of:
population-related data and treatment-scenario data.

21. The apparatus of claim 20, wherein the plurality of combinations of input variables comprises any one data of: treatment data, biomarkers data, disease risk data and population data; wherein the response variables comprise any one data of: disease event rates and other statistical information.
